(19) United States
(12) Patent Application Publication
(10) Pub. No.: US 2020/0368789 A1
(43) Pub. Date: Nov. 26, 2020

(54) SINGLE AXIS ROBOT

(71) Applicant: SUGINO MACHINE LIMITED, Uozu City (JP)

(72) Inventors: Akihiro ISHITANI, Uozu City (JP); Takuya AOKI, Uozu City (JP)

(73) Assignee: SUGINO MACHINE LIMITED

(21) Appl. No.: 15/931,858

(22) Filed: May 14, 2020

(30) Foreign Application Priority Data
May 22, 2019 (JP) 2019-095917

(51) Int. Cl. B08B 3/02; F16H 25/22; F16H 57/031; B25J 19/00; B25J 15/00; B08B 13/00

(52) U.S. Cl. CPC B08B 3/02; F16H 25/2204; F16H 57/031; F16H 2025/2031; B25J 15/00; B08B 13/00; B25J 19/0083

(57) ABSTRACT

A single-axis robot in which a ball screw or a linear guide can be easily replaced is provided. A single axis robot, includes: a housing including, on a first side, a base plate having a first saddle hole; a support plate arranged in a second side of the housing; a linear guide arranged inside the housing along the base plate, the linear guide extending along the first saddle hole; a slider arranged inside the housing on the linear guide, the slider configured to slide along the linear guide; a saddle arranged on the first side of the slider to protrude to an outside of the housing through the first saddle hole; a driving device arranged on the second side of the slider to drive the slider; and a telescopic cover arranged outside the housing between the base plate and the saddle.

### CROSS-REFERENCE TO RELATED APPLICATIONS

This application claims the benefit of priority to Japanese Patent Application No. 2019-095917, filed on May 22, 2019, the entire contents of which are hereby incorporated by reference.

### BACKGROUND

### 1. Technical Field

The present invention relates to a single axis robot.

### 2. Description of the Background

A conventional single axis robot includes a box-shaped housing, a pair of linear guides, a slider, a ball screw, a motor, and a cover. The housing has an opening on one side. The pair of linear guides is disposed inside the housing. The slider slides on the pair of linear guides. The ball screw is disposed inside the housing. The motor is connected to the ball screw. The cover covers a space between the opening and the slider. As the conventional single axis robot, for example, THK Corporation, “Precision Stage Series A/AX, CMX. CHX THK Electric Actuator”. Page 5, <URL:https://tech.thk.com/upload/product_data/upfile/precision_stage_series.pdf?_ga=2.6214244.1177243993.1557715664-1848377462.1557715664>, hereinafter, “Non-Patent Literature 1” is known.

### BRIEF SUMMARY

When replacing the ball screw or the linear guides of the single axis robot of Non-Patent Literature 1, the cover of the saddle side needs to be removed.

An object of the present invention is to provide a single axis robot in which a ball screw or a linear guide can be easily replaced.

A first aspect of the present invention provides a single axis robot, including:

a housing including, on a first side, a base plate having a first saddle hole;

a support plate arranged in a second side of the housing;

a linear guide arranged inside the housing along the base plate, the linear guide extending along the first saddle hole;

a slider arranged inside the housing on the linear guide, the slider configured to slide along the linear guide;

a saddle arranged on the first side of the slider to protrude to an outside of the housing through the first saddle hole;

a driving device arranged on the second side of the slider to drive the slider; and

a telescopic cover arranged outside the housing between the base plate and the saddle.

According to the single axis robot of the present invention, the ball screw or the linear guide is easily replaced.

### BRIEF DESCRIPTION OF DRAWINGS

FIG. 1 is a perspective view of a cleaning apparatus applying a single axis robot according to the embodiment.

FIG. 2 is a perspective view of the single axis robot according to the embodiment.

FIG. 3 is a perspective view of the single axis robot according to the embodiment.

FIG. 4 is a cross-sectional view taken along IV-IV in FIG. 1.

FIG. 5 is a cross-sectional view taken along V-V in FIG. 4.

### DETAILED DESCRIPTION

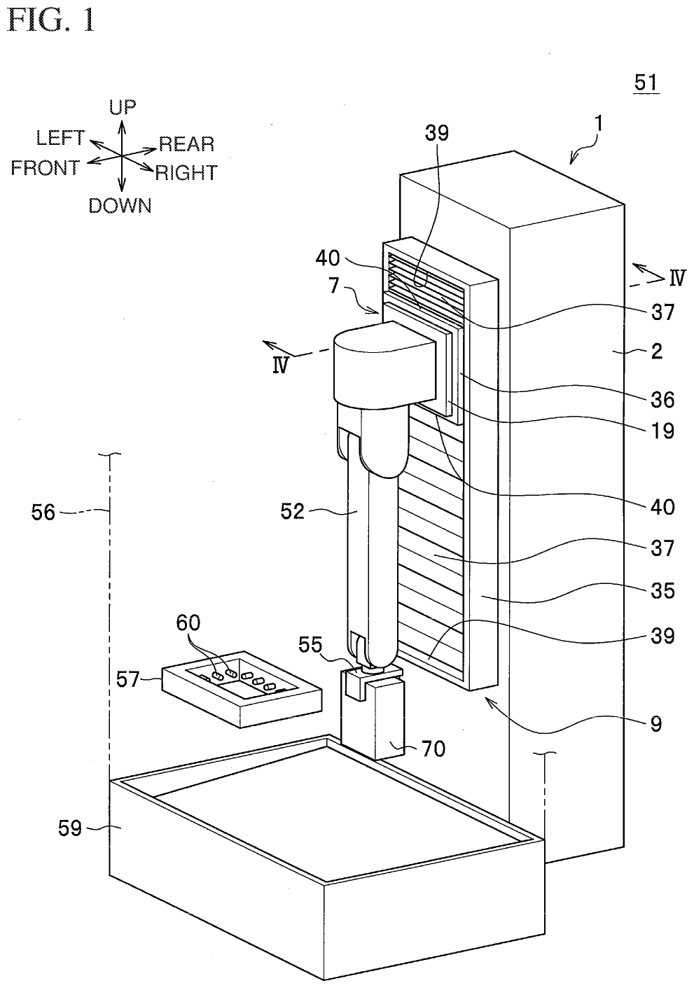

As shown in FIG. 1, a cleaning apparatus 51 includes a cover 56, a table 59, a single axis robot 1, an arm 52, a hand 55, a nozzle 60, and a nozzle block 57. The single axis robot 1 includes a housing 2, and a telescopic cover 9. The housing 2 is disposed upright behind the table 59. The arm 52 is arranged on a saddle 7. The arm 52 is, for example, a five-axis arm. The hand 55 is disposed at the distal end of the arm 52, and grips a workpiece 70. The cover 56 is disposed above the table 59. The cover 56 covers the arm 52, the nozzle 60, and the nozzle block 57. The single axis robot 1 drives the arm 52 in the vertical direction. The arm 52 moves the workpiece 70. The arm 52 moves the workpiece 70 to face the nozzle 60, and cleans the workpiece 70 with the cleaning liquid ejected from the nozzle 60. The cleaning liquid collides with the workpiece 70 and is scattered. The telescopic cover 9 suppresses vapor and cleaning liquid jet filled inside the cover 56 from entering the housing 2.

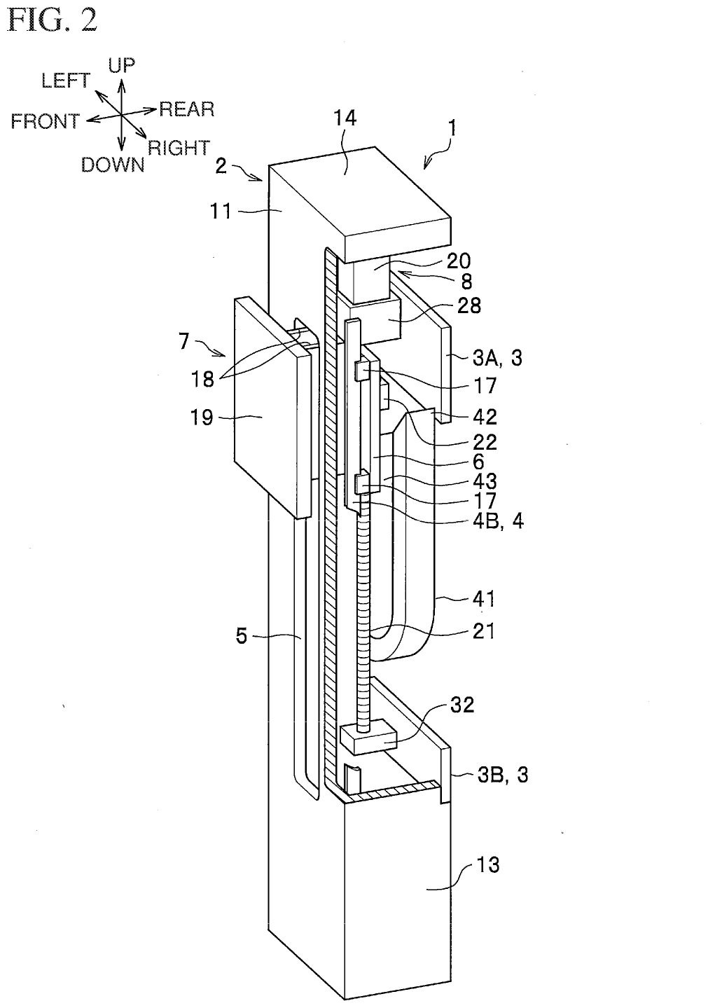

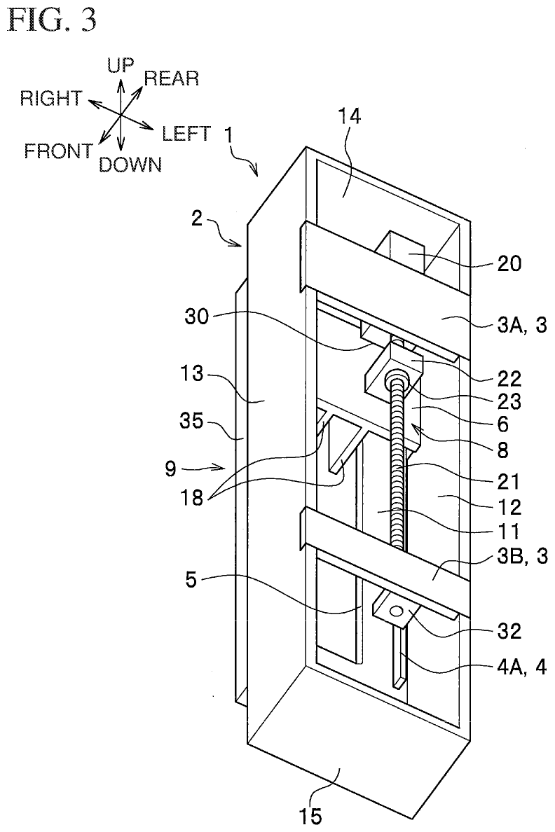

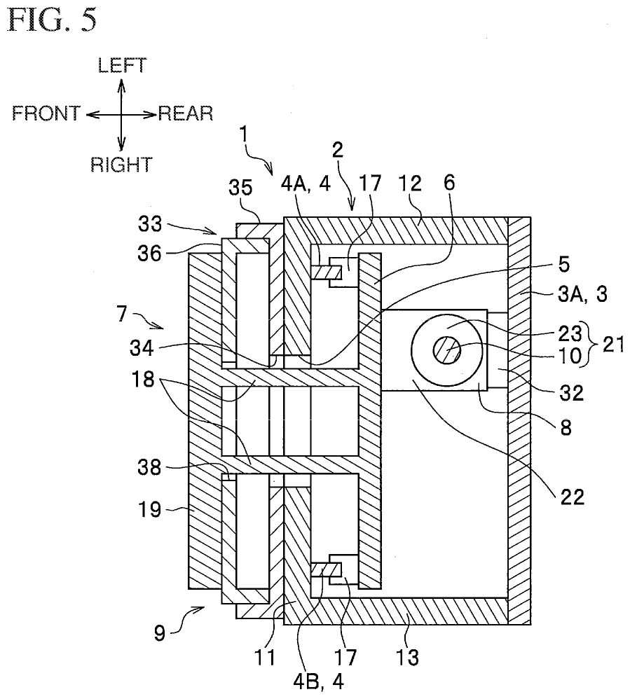

Hereinafter, for convenience of explanation, as shown in FIGS. 2 to 5, the vertical, lateral, and front-rear directions are defined for the single axis robot 1. However, the direction is an example, and the actual installation direction of the single axis robot 1 is not limited.

The single axis robot 1 includes a housing 2, a support plate 3, a linear guide 4, a first saddle hole 5, a slider 6, a saddle 7, and a driving device 8. The single axis robot 1 may include a cable protection tube 41 disposed inside the housing 2.

The housing 2 includes a base plate 11. The base plate 11 is disposed in a front side (first side) of the housing 2. The housing 2 is a box-shaped body, and has an opening, for example, at the rear side (second side). The housing 2 includes, for example, side plates 12, 13 on the left and right sides. The base plate 11 has a first saddle hole 5. The first saddle hole 5 extends vertically at the center of the base plate 11.

The support plate 3 is disposed behind the housing 2. The support plate 3 is disposed apart from the base plate 11. The support plate 3 is disposed across the side plates 12 and 13, for example. The support plate 3 is accurately positioned, for example, by positioning pins. The support plate 3 is detachable from the housing 2. The support plate 3 may include a motor support plate 3A and a shaft end support plate 3B.

The motor support plate 3A is disposed in the upper part of the housing 2. The motor support plate 3A includes a motor bracket 28, a bearing 29 and a bearing holder 30.

The motor bracket 28 is disposed in front of the motor support plate 3A. The bearing holder 30 is disposed in front of the motor support plate 3A. The bearing holder 30 holds the bearing 29. The motor support plate 3A is detachable from the housing 2.

The shaft end support plate 3B is disposed in the lower part of the housing 2. The shaft end support plate 3B includes a bearing 31 and a bearing holder 32. The bearing holder 32 is disposed in a front side (first side) of the shaft end support plate 3B. The bearing holder 32 holds the bearing 31. The shaft end support plate 3B is detachable from the housing 2.

A pair of two linear guides 4 includes guide blocks 17. The linear guide 4 extends vertically, and is disposed on the rear surface of the base plate 11. The linear guide 4 includes a linear guides 4A, 4B. The linear guides 4A, 4B are arranged on the right and left of the first saddle hole 5, respectively. The guide block 17 is disposed on the linear guide 4, and slides on the linear guide 4.

The slider 6 is disposed on the linear guide 4A, 4B via the guide blocks 17. The slider 6 is in a plate having a rectangular shape when viewed in the front-rear direction. The slider 6 includes a nut holder 22. The nut holder 22 is disposed on the rear surface side of the slider 6. The slider 6 is disposed on the rear surface side of the base plate 11.

The saddle 7 includes a pillar 18 and a saddle plate 19. The saddle 7 is formed on the front end (first side) of the slider 6 to protrude to the outside of the housing 2 through the first saddle hole 5. The pillar 18 is fixed to the front surface of the slider 6, and passes through the first saddle hole 5. For example, the pillar 18 is a pair of left and right plate-like members each extending along the front-rear direction. The saddle plate 19 is fixed to the front end of the pillar 18 to be disposed outside the housing 2. The saddle plate 19 has a rectangular shape when viewed in the front-rear direction. The saddle plate 19 is disposed in a vertical plane on the front side of the base plate 11 in parallel with the base plate 11.

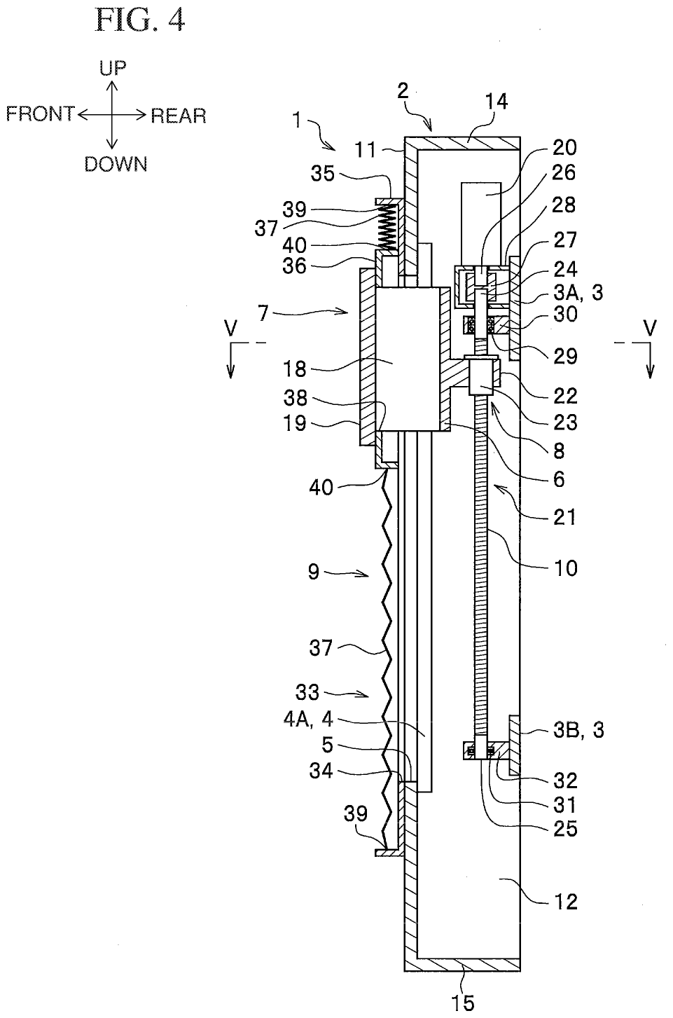

As shown in FIG. 4, the driving device 8 is, for example, a ball screw mechanism. The driving device 8 includes a motor 20, a ball screw 21, and a coupling 27. The driving device 8 extends in the vertical direction. The driving device 8 is disposed on the rear side (second side) of the slider 6. The driving device 8 drives the slider 6.

The ball screw 21 includes a screw shaft 10 and a nut 23. The ball screw 21 includes a motor end 24, and a shaft end 25. The shaft end 25 is supported by the bearing 31. The motor end 24 is supported by the bearing 29. The nut 23 is fixed to the nut holder 22.

The motor 20 is supported by the motor support plate 3A via the motor bracket 28. The motor 20 includes an output shaft 26. The motor 20 is, for example, a servo motor or a stepping motor. The motor 20 is disposed with the output shaft 26 facing downward.

The coupling 27 directly fastens the output shaft 26 and the screw shaft 10.

The telescopic cover 9 is disposed between the base plate 11 and the saddle plate 19. The telescopic cover 9 includes a box 35, a moving box 36, and a bellows 37.

The box 35 has an opening 33 at the front (first side), and has a second saddle hole 34 at the rear (second side). The box 35 has an elongated shape flattened in the front-rear direction, and is attached to the front surface of the base plate 11. The second saddle hole 34 has substantially the same longitudinal shape as the first saddle hole 5, and is disposed so as to overlap with the first saddle hole 5.

The moving box 36 is disposed on the rear surface of the saddle plate 19. The moving box 36 has a box shape flattened in the front-rear direction. The lateral width of the moving box 36 is smaller than the internal lateral width of the box 35. The moving box 36 has a through hole 38. The moving box 36 may be fixed to the saddle plate 19.

The bellows 37 includes a fixed end 39 and a moving end 40. The fixed end 39 is fixed to the box 35. The moving end 40 is fixed to the moving box 36. The bellows 37 are arranged on both sides of the moving box 36 in the moving direction, that is, above and below the moving box 36 in the present embodiment.

The pillar 18 passes through the second saddle hole 34 and the through hole 38. The moving box 36 moves together with the saddles 7 along the linear guides 4A, 4B in the box 35.

As shown in FIG. 2, the cable protection tube 41 includes a fixed end 42, and a moving end 43. The fixed end 42 is fixed to the motor support plate 3A. The moving end 43 is fixed to the rear end of the saddle 7. The cable protection tube 41 is disposed so as to hang down in a U-shape. Inside the cable protection tube 41, for example, a signal cable connected to the arm 52, an air pipe, a power cable or the like is accommodated.

By removing the nut 23 from the nut holder 22, and removing the support plate 3 from the housing 2, the driving device 8 is easily detached from the housing 2. As the telescopic cover 9 is disposed between the base plate 11 and the saddle plate 19, the penetration of the cleaning liquid and foreign matter into the inside of the housing 2 is suppressed.

It should be noted that the present invention is not limited to the embodiments described above, and various modifications can be made without departing from the gist of the present invention, and all technical matters included in the technical idea described in the claims are the subject matter of the present invention. While the foregoing embodiments illustrate preferred examples, those skilled in the art will appreciate that various alternatives, modifications, variations, or improvements may be made in light of the teachings disclosed herein and are within the scope of the appended claims.

### REFERENCE SIGNS LIST

1 Single axis robot
2 Housing
3 Support plate
3A Motor support plate
3B Shaft end support plate
4 Linear guide
4A, 4B linear guide
5 First saddle hole
6 Slider
7 Saddle
8 Driving device
9 Telescopic cover
11 Base plate
18 Pillar
19 Saddle plate
20 Motor
21 Ball screw
23 Nut
24 Motor end
25 Shaft end
33 Opening
34 Second saddle hole
35 Box
36 Moving box
37 Bellows
39 Fixed end
40 Moving end
41 Cable protection tube
42 Fixed end
43 Moving end

What is claimed is:

1. A single axis robot, comprising:
a housing including, on a first side, a base plate having a first saddle hole;
a support plate arranged in a second side of the housing;
a linear guide arranged inside the housing along the base plate, the linear guide extending along the first saddle hole;
a slider arranged inside the housing on the linear guide, the slider configured to slide along the linear guide;
a saddle arranged on the first side of the slider to protrude to an outside of the housing through the first saddle hole;
a driving device arranged on the second side of the slider to drive the slider; and
a telescopic cover arranged outside the housing between the base plate and the saddle.

2. The single axis robot according to claim 1, wherein
the driving device includes
a motor, and
a ball screw connected to the motor, the ball screw including
a motor end, and
a shaft end opposite to the motor end,
the support plate includes
a motor support plate supporting the motor and the motor end, and
a shaft end support plate supporting the shaft end.

3. The single axis robot according to claim 1, wherein
the support plate is detachably arranged on the housing.

4. The single axis robot according to claim 1, wherein
the linear guide includes a pair of two linear guides arranged parallel to the base plate, and
the first saddle hole is arranged between the two linear guides.

5. The single axis robot according to claim 1, wherein
the saddle includes
a pillar fixed to the slider through the first saddle hole, and
a saddle plate fixed to an end of the pillar, the saddle plate arranged outside the housing.

6. The single axis robot according to claim 1, wherein
the telescopic cover includes
a box arranged on the base plate, the box having an opening on the first side, and a second saddle hole on the second side,
a moving box configured to move together with the saddle inside the box along the linear guide with the saddle passing through an inside of the box, and
a bellows including a fixed end fixed to the box and a moving end fixed to the moving box, the bellows arranged on both sides of the moving box in a moving direction.

7. The single axis robot according to claim 2, further comprising:
a cable protection tube arranged in the housing, the cable protection tube including
a fixed end fixed to the motor support plate, and
a moving end fixed to the second side of the saddle.

8. The single axis robot according to claim 2, wherein
the support plate is detachably arranged on the housing.

9. The single axis robot according to claim 2, wherein
the linear guide includes a pair of two linear guides arranged parallel to the base plate, and
the first saddle hole is arranged between the two linear guides.

10. The single axis robot according to claim 3, wherein
the linear guide includes a pair of two linear guides arranged parallel to the base plate, and
the first saddle hole is arranged between the two linear guides.

11. The single axis robot according to claim 2, wherein
the saddle includes
a pillar fixed to the slider through the first saddle hole, and
a saddle plate fixed to an end of the pillar, the saddle plate arranged outside the housing.

12. The single axis robot according to claim 3, wherein
the saddle includes
a pillar fixed to the slider through the first saddle hole, and
a saddle plate fixed to an end of the pillar, the saddle plate arranged outside the housing.

13. The single axis robot according to claim 4, wherein
the saddle includes
a pillar fixed to the slider through the first saddle hole, and
a saddle plate fixed to an end of the pillar, the saddle plate arranged outside the housing.

14. The single axis robot according to claim 2, wherein
the telescopic cover includes
a box arranged on the base plate, the box having an opening on the first side, and a second saddle hole on the second side,
a moving box configured to move together with the saddle inside the box along the linear guide with the saddle passing through an inside of the box, and
a bellows including a fixed end fixed to the box and a moving end fixed to the moving box, the bellows arranged on both sides of the moving box in a moving direction.

15. The single axis robot according to claim 3, wherein
the telescopic cover includes
a box arranged on the base plate, the box having an opening on the first side, and a second saddle hole on the second side,
a moving box configured to move together with the saddle inside the box along the linear guide with the saddle passing through an inside of the box, and
a bellows including a fixed end fixed to the box and a moving end fixed to the moving box, the bellows arranged on both sides of the moving box in a moving direction.

16. The single axis robot according to claim 4, wherein
the telescopic cover includes
a box arranged on the base plate, the box having an opening on the first side, and a second saddle hole on the second side,
a moving box configured to move together with the saddle inside the box along the linear guide with the saddle passing through an inside of the box, and
a bellows including a fixed end fixed to the box and a moving end fixed to the moving box, the bellows arranged on both sides of the moving box in a moving direction.

17. The single axis robot according to claim 5, wherein
the telescopic cover includes
a box arranged on the base plate, the box having an opening on the first side, and a second saddle hole on the second side,
a moving box configured to move together with the saddle inside the box along the linear guide with the saddle passing through an inside of the box, and
a bellows including a fixed end fixed to the box and a moving end fixed to the moving box, the bellows arranged on both sides of the moving box in a moving direction.
